(19) United States
(12) Patent Application Publication
(10) Pub. No.: US 2020/0326761 A1
(43) Pub. Date: Oct. 15, 2020

(54) Computer Case Having Improved Accessibility To Both Heat Dissipation And Expansions

(71) Applicant: Mike Huang, Guangdong (CN)

(72) Inventor: Mike Huang, Guangdong (CN)

(21) Appl. No.: 16/446,603

(22) Filed: Jun. 19, 2019

(30) Foreign Application Priority Data
Apr. 15, 2019 (TW) 108204585

(51) Int. Cl. G06F 1/20; G06F 1/18

(52) U.S. Cl. CPC G06F 1/20; G06F 1/181

(57) ABSTRACT

A computer case having improved accessibility to heat dissipation and expansions, whereby the case provides a space for installing a motherboard, and the case at least having a front panel, a top panel which is mutually perpendicular to the front panel, a rear panel, and a motherboard installation area, wherein the front panel and the rear panel are mutually parallel and respectively provided with at least one inlet fan and at least one outlet fan, an I/O port group included in the motherboard is correspondingly installed on the top panel of the case, such that a video card is in direct correspondence with the inlet fan (the outlet fan) of the rear (front) panel, and the video card faces an air inlet or an air outlet of the inlet fan or the outlet fan with a maximum area, thereby achieving high heat dissipation efficiency as well.

### CROSS REFERENCES TO RELATED APPLICATIONS

The present application claims priority from Taiwanese Patent Application Serial Number 108204585, filed Apr. 15, 2019 the disclosure of which is hereby incorporated by reference herein in its entirety.

### BACKGROUND OF THE INVENTION

### (a) Field of the Invention

The present invention relates to a computer case and, more particularly, to computer case structure having improved accessibility to both heat dissipation and expansions.

### (a) Description of the Prior Art

Generally, the operations of a computer generate a massive amount of heat inside a computer case (abbreviated as a case C); in order to prevent the heat from accumulating excessively and causing the computer to crash or electronic elements thereof to be damaged, the current case C is provided with a heat dissipation device, such as: a front inlet fan F1, a rear outlet fan F2 and the like, so as to discharge the heat inside the case C to an external environment (as shown in FIG. 1).

An internal portion of the current case C is divided into installation areas including a motherboard installation area M, an optical drive installation area D, a power supply unit installation area P and the like (as shown in FIG. 1). However, the installation areas are respectively in correspondence with a front panel C1, a top panel C2 and a rear panel C3 of the case C; the optical drive installation area D is in correspondence with the front panel C1, the motherboard installation area M has connectors V1 of an I/O port M1 and a video card V which is therefore in correspondence with the rear panel C3, and the power supply unit installation area P is similarly in correspondence with the rear panel C3 because the power supply unit installation area P needs to be connected to a power supply cable (not shown in the figure).

It is known that the above-mentioned architecture is the most common and the most traditional internal configuration for the case C (as shown in FIG. 1), and two major disadvantages were found over long term uses:

Poor heat dissipation efficiency, whereby the top major heat generation source in the motherboard installation area M is from the CPU (Central Processing Unit), while the second major heat generation source should be the video card V. Generally speaking, the CPU is equipped with a fully developed heat dissipation system (for example: a water-cooling heat dissipation system) having uniform size and standard, however, due to the fact that the size and standard of the video card V are inconsistent as well as the warranty restrictions, these factors causing the video card V being rarely provided with a specialized heat dissipation system. In addition, it can be seen from the above-mentioned configuration that, a contact surface area between the video card V and ports of fans is the least, thus a poor heat dissipation effect is expectable;

troublesome expansions of plugging and unplugging: regarding the above-mentioned configuration, the connectors V1 of the I/O port M1 and the video card V of the motherboard installation area M are all in correspondence with the rear panel C3; for example, the configuration is troublesome to a computer player or a user who frequently needs to perform expansions by adding other devices, whereby the connectors V1 of the I/O port M1 on the rear panel C3 cannot be accessed unless the case is moved.

Therefore, the purpose of the present invention is to find a simplest way to improve the above-mentioned traditional case, such that the case has improved accessibility to both high heat dissipation efficiency and expansions.

### SUMMARY OF THE INVENTION

A major object of the present invention is to provide a computer case having improved accessibility to both heat dissipation and expansions, in which a character of a motherboard having an I/O port and a video card installed perpendicularly to each other is employed, so as to turn a traditional computer motherboard 90 degrees and install the same in the computer case, such that the I/O port of the motherboard facing towards and is installed on a top panel of the case; accordingly, convenient expansions of plugging and unplugging can be achieved, and the massive heat-generating video card is enabled to be contacted with cool air with a maximum surface area.

To achieve the above-mentioned purpose, the present invention provides a computer case having improved accessibility to both heat dissipation and expansions, in which the case provides a space for installing a motherboard, and the case at least includes: a front panel, a top panel which is mutually perpendicular to the front panel, a rear panel, and a motherboard installation area for installing a computer motherboard, wherein the front panel and the rear panel are mutually parallel and respectively provided with at least one inlet fan and at least one outlet fan, and the motherboard has at least an I/O port and a video card arranged perpendicularly to each other, characterized in that: the I/O port of the motherboard is correspondingly installed on a top panel of the case, such that the video card of the motherboard correspondingly faces the inlet fan or the outlet fan of the rear panel with a maximum surface area, thereby achieving improved accessibility to heat dissipation and expansions.

On the basis of the above-mentioned main features, wherein the top panel of the case is capable of providing a connector accommodation space so as to accommodate expansion connectors and enable the connectors to be plugged outside of the I/O port group, moreover to enable multiple effects such as cable organizing and cable bundling.

On the basis of the above-mentioned main features, wherein the connector accommodation space can further be provided with a dust cover for modifying the appearance of the case and serving the purpose of dust-proof.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view showing an architecture of a general computer case.

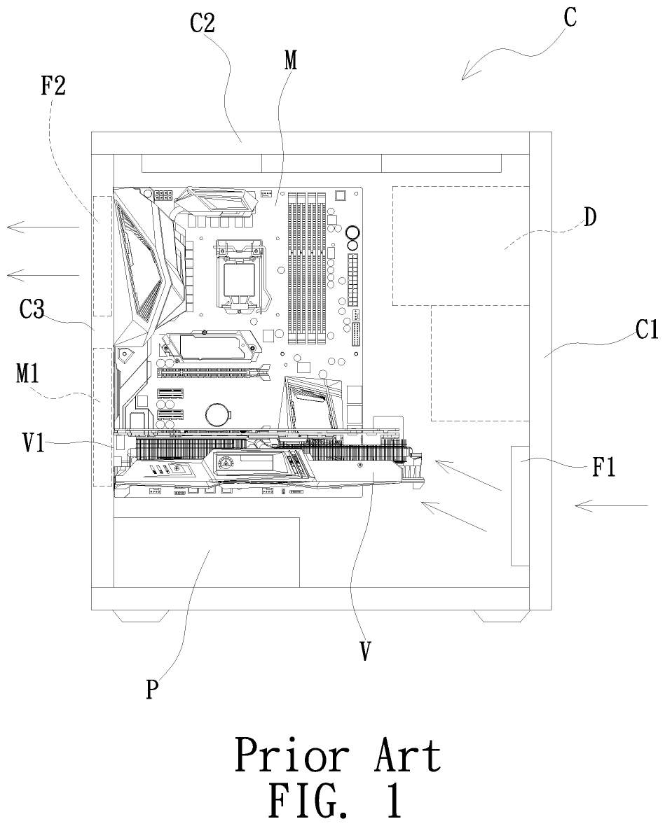

FIG. 2 is a schematic view showing an architecture of a computer case having improved accessibility to both heat dissipation and expansions according to the present invention.

FIG. 3 is a schematic view showing an appearance of the computer case having improved accessibility to both heat dissipation and expansions according to the present invention, in which a top panel of the case having a connector accommodation space is shown.

### DETAILED DESCRIPTION OF THE PREFERRED EMBODIMENTS

To achieve the above-mentioned or other objects and effects, the features and functions of the technical means and structures employed in the present invention are illustrated in details by using drawings and preferred embodiments of the present invention as described below, so as to facilitate complete understanding.

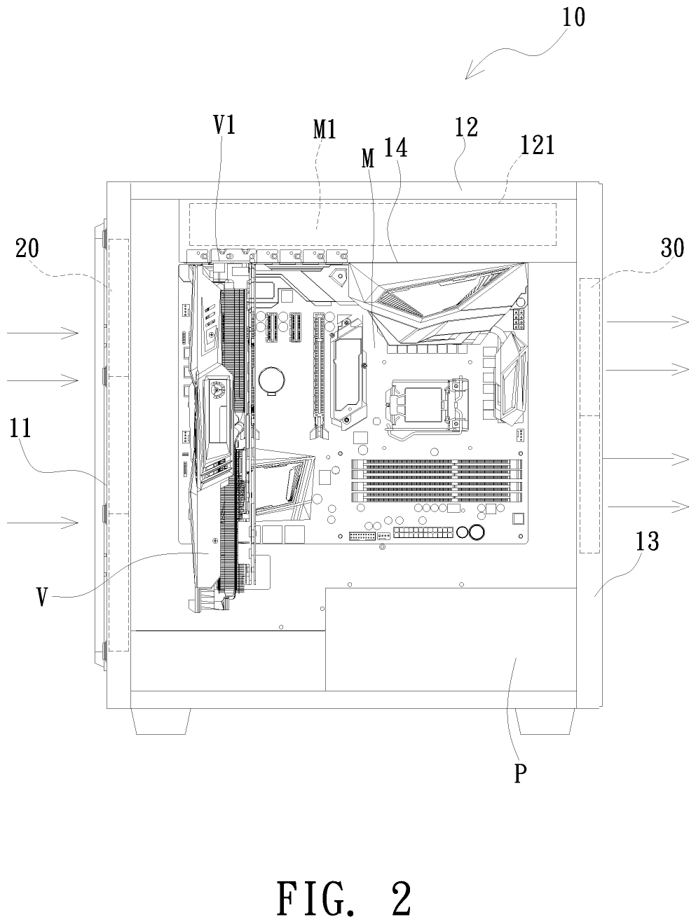

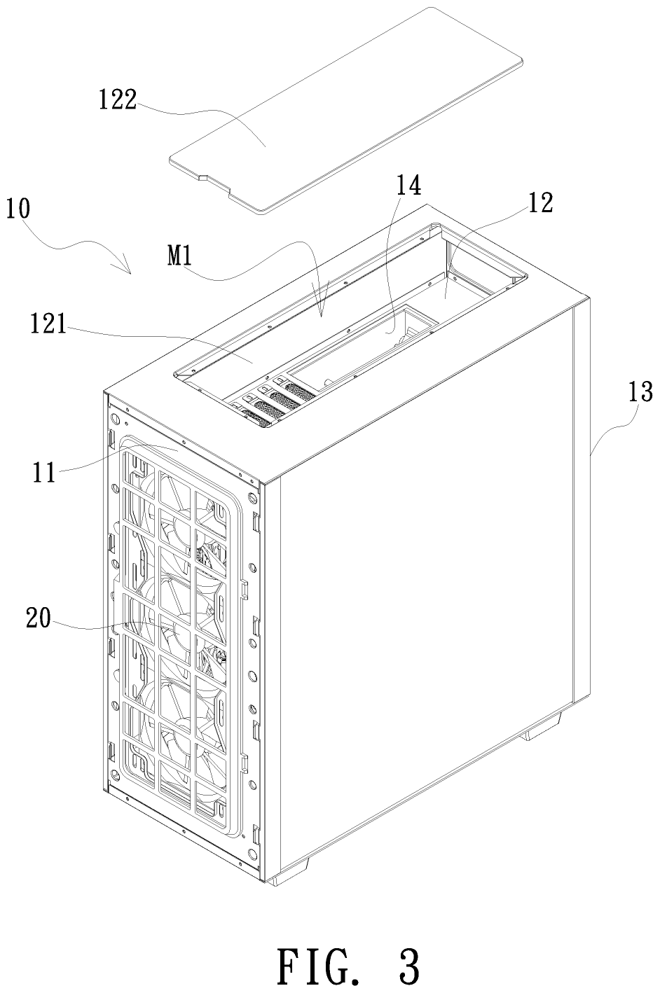

Referring to FIGS. 2 and 3; FIG. 2 is a schematic view showing an architecture of a computer case having improved accessibility to both heat dissipation and expansions according to the present invention, while FIG. 3 is a schematic view showing an appearance of the computer case having improved accessibility to both heat dissipation and expansions according to the present invention, in which a top panel of the case having a connector accommodation space is shown.

As shown in the drawings, the present invention provides a computer case having improved accessibility to both heat dissipation and expansions; a case 10 of the present invention is at least provided with a space for installing a motherboard M, the case 10 at least includes: a front panel 11, a top panel 12 which is mutually perpendicular to the front panel 11, a rear panel 13, and a motherboard installation area 14 for installing the computer motherboard M, said features are described in further details that:

the front panel 11 and the rear panel 13 are mutually parallel and may have at least one inlet fan 20 and at least one outlet fan 30 installed thereon according to actual requirements; whether the inlet fan 20 and the outlet fan 30 are respectively installed on the front panel 11 or the rear panel 13 are determined according to actual requirements and is not limited by the present invention; in addition, apart from a generally recognized CPU and a memory (not shown in the drawings), the motherboard M of the present invention has an I/O port M1 and a video card V which are arranged perpendicularly to each other (as shown in FIG. 2);

the present invention mainly seeks to protect: the I/O port M1 included in said motherboard M is correspondingly installed on the top panel 12 of the case 10 (as shown in FIGS. 2 and 3), such that the video card V of the motherboard M correspondingly faces the inlet fan 20 or the outlet fan 30 of the rear panel 13 with a maximum surface area (as shown in FIG. 2), thereby achieving improved accessibility to both heat dissipation and expansions.

In addition, apart from enabling the I/O port M1 of the motherboard to face towards and be installed on the top panel 12 of the case 10, the present invention is provided with a connector accommodation space 121 on the top panel 12 (as shown in FIG. 2) which is used to accommodate expansion connectors and enable the connectors to be plugged on the I/O port M1; the connector accommodation space 121 is further provided with a dust cover 122 thereon (as shown in FIG. 3) for modifying appearance of the case 10 and serving the purpose of dust-proof.

In summary, the present invention is advantageous in that: the character in which the I/O port M1 and the video card V of the motherboard M are installed perpendicularly to each other is utilized, so as to enable the I/O port M1 of the motherboard M to face towards and be installed on the top panel 12 of the case 10 in achieving improved accessibility to expansions of plugging and unplugging, and the massive heat-generating video card V is enabled to be contacted with cool air with a maximum surface area.

However, it should be understood that the aforesaid descriptions are merely preferred embodiments of the present invention and are not intended to limit the scope of the present invention; therefore, simple modifications and equivalent structural variations based on the description and the drawings of the present invention shall be likewise included within the scope of present invention.

1. A computer case having accessibility to both heat dissipation and expansions, wherein the case provides a space for installing a computer motherboard, and the computer case at least comprises: a front panel, a top panel mutually perpendicular to the front panel, a rear panel, and a motherboard installation area; the front panel and the rear panel are mutually parallel and respectively provided with at least one inlet fan and at least one outlet fan, and the computer motherboard is provided with at least an I/O port and a video card arranged perpendicularly to each other, wherein the I/O port is correspondingly installed on the top panel of the case and the video card is installed along a first direction substantially perpendicular to the top panel, such that the video card correspondingly faces the inlet fan or the outlet fan of the rear panel or the front panel with a maximum surface area, and the inlet fan and the outlet fan form an air flow along a second direction substantially perpendicular to the first direction.

2. The computer case having improved accessibility to both heat dissipation and expansions of claim 1, wherein the top panel of the case is capable of providing a connector accommodation space for accommodating expansion connectors and enabling the connectors to be plugged to the I/O port.

3. The computer case having accessibility to both heat dissipation and expansions of claim 2, wherein the connector accommodation space is further provided with a dust cover for modifying appearance of the case and serving purpose of dust-proof.

4. The computer case having accessibility to both heat dissipation and expansions of claim 2, wherein the top panel of the case is formed a rectangle opening to access the connector accommodation space.

5. The computer case having accessibility to both heat dissipation and expansions of claim 4, wherein the top panel of the case further comprises a dust cover covering the rectangle opening.

6. The computer case having accessibility to both heat dissipation and expansions of claim 5, wherein a top surface of the dust cover is coplanar to a top surface of the top panel.
